(19) United States
(12) Patent Application Publication
(10) Pub. No.: US 2022/0339620 A1
(43) Pub. Date: Oct. 27, 2022

(54) METHOD FOR PREPARING MICRO-CHANNEL ARRAY PLATE, DEVICE FOR OBTAINING LIQUID DROPS USING THE MICRO-CHANNEL ARRAY PLATE, AND METHOD FOR GENERATING LIQUID DROPS

(71) Applicant: Enumerix, Inc., Palo Alto, CA (US)

(72) Inventors: Yanyi HUANG, Beijing (CN); Zitian CHEN, Beijing (CN); Peiyu LIAO, Beijing (CN); Fangli ZHANG, Beijing (CN)

(21) Appl. No.: 17/856,749

(22) Filed: Jul. 1, 2022

Related U.S. Application Data
(63) Continuation of application No. 16/309,092, filed on Aug. 15, 2019.

(30) Foreign Application Priority Data
Jun. 12, 2016 (CN) 201610409019.0

(51) Int. Cl. B01L 3/02

(52) U.S. Cl. CPC B01L 3/0241; B01L 2200/061; B01L 2200/12; B01L 2300/0829; B01L 2300/0861; B01L 2300/165; B01L 2400/0409

(57) ABSTRACT

The present invention discloses a method for preparing a micro-channel array plate, comprising the steps of : (1) arranging a first optical fiber glass rod and a second optical fiber glass rod closely, melting the two glass rods into a whole at a high temperature to obtain a melted glass rod, drawing the melted glass rod at least one time into a longer and thinner glass rod than the melted glass rod, and cutting the drawn glass rod into small pieces to obtain a micro-channel array plate blank, wherein the corrosion resistance of the first optical fiber glass rod and the second optical fiber glass rod to the same corrosive liquid is different; (2) corroding the micro-channel array plate blank by a corrosive liquid to obtain a micro-channel array plate crude product with through holes; and (3) conducting hydrophobic treatment on the micro-channel array plate crude product to obtain the micro-channel array plate.

### CROSS-REFERENCE

The present application is a continuation application of U.S. patent application Ser. No. 16/309,092, filed Aug. 15, 2019, which is a U.S. National Phase Application under 35 U.S.C. § 371 of International Patent Application No. PCT/CN2017/085891, filed May 25, 2017, which claims priority to Chinese Patent Application No. CN201610409019.0, filed Jun. 12, 2016, the entirety of each of which is incorporated by reference herein.

### TECHNICAL FIELD

Examples of the present invention relates to a method for preparing a micro-channel array plate, a device for obtaining droplets using the micro-channel array plate, and a method for generating droplets.

### BACKGROUND

The emulsion droplet technology plays a vital role in many molecular biology experiments. Uniform and stable droplets that are compatible with biological experiments have been applied in many technologies and applications. Among those technologies and applications, technologies and methods such as cell culture, sample separation, digital polymerase chain reactions, and emulsion whole genome amplification are common methods. The droplet technology is likely to be the cornerstone of next-generation sequencing, third-generation PCR reactions, and related high-throughput bioassays. Many isolated and independent solution environments caused by droplets can, on one hand, form many tiny reaction vessels, greatly reducing the amount of samples to be used; and on the other hand, digitally detect samples having an extremely low content by means of amplification, which is an excellent option for unimolecular amplification reactions.

At present, most common methods for producing water-in-oil droplets are conducted by microfluidic chips. However, such methods are costly, time-consuming and labor-intensive, and easily causes sample contamination in the laboratory. Meanwhile, the microfluidic method requires a clean environment and an accurate pressure control system. Even if the hardware and the experimental environment are satisfied, the microfluidic method also needs long-term debugging and exploration. Due to these problems, it is difficult to obtain wider applications of microfluidic devices commonly found in bioanalytical chemistry laboratories.

### SUMMARY

Examples of the present invention provides a method for preparing a micro-channel array plate, comprising the steps of: (1) arranging a first optical fiber glass rod and a second optical fiber glass rod closely, melting the two glass rods into a whole at a high temperature to obtain a melted glass rod, drawing the melted glass rod at least one time into a longer and thinner glass rod than the melted glass rod, and cutting the drawn glass rod into small pieces to obtain a micro-channel array plate blank, wherein the corrosion resistance of the first optical fiber glass rod and the second optical fiber glass rod to the same corrosive liquid is different; (2) corroding the micro-channel array plate blank by a corrosive liquid to obtain a micro-channel array plate crude product with through holes; and (3) conducting hydrophobic treatment on the micro-channel array plate crude product to obtain the micro-channel array plate.

According to an embodiment of the present invention, for example, the first optical fiber glass rod can be almost completely corroded by a corrosive liquid and the second optical fiber glass rod is almost not corroded by the same corrosive liquid; or conversely, the second optical fiber glass rod can be almost completely corroded by a corrosive liquid and the first optical fiber glass rod is almost not corroded by the same corrosive liquid.

According to an embodiment of the present invention, for example, the corrosive liquid is nitric acid and caustic soda; the concentration of the nitric acid is not more than 1 mol/L, for example, 0.3-0.5 mol/L, and the concentration of the caustic soda is not more than 2 mol/L, for example, 0.5 mol/L.

According to an embodiment of the present invention, for example, the step of corroding the micro-channel array plate blank by the corrosive liquid to obtain a micro-channel array plate crude product with through holes comprises: ultrasonically soaking the micro-channel array plate blank in a nitric acid solution for a certain period of time, then taking out, cleaning and ultrasonically soaking the micro-channel array plate blank in a caustic soda solution for a certain period of time, and then continuing to corrode the micro-channel array plate blank in an acid liquid, then repeating the above steps; wherein a small amount of fluorine ions are doped into the corrosive liquid.

According to an embodiment of the present invention, for example, a reagent used for the hydrophobic treatment is a fluorine-based hydrophobic reagent, and the fluorine-based hydrophobic reagent comprises: fluoroalkane, or fluorosilane; the fluorosilane comprises at least one of trimethylchlorosilane, trisperfluoromethylchlorosilane, trimethoxypropylsilane, trimethoxy 1H,1H,2H,2H-perfluorooctylsilane, propyltrichlorosilane, 1H,1H,2H,2H-perfluorooctyltrichlorosilane, (2,4-difluorophenylethynyl)trimethylsilane, (3,5-difluorophenylethynyl)trimethylsilane, (3,5-bis(trifluoromethyl)phenylethynyl)trimethylsilane, triethyl(trifluoromethyl)silane, triethoxy[4-(trifluoromethyl)phenyl]silane, chlorodimethyl(pentafluorophenyl)silane, 1H,1H,2H,2H-perfluorooctyltrichlorosilane, 1H,1H,2H,2H-perfluorooctyldimethylmonochlorosilane, octyltrichlorosilane or octyldimethylmonochlorosilane, 1H,1H,2H,2H-perfluorododecyltrichlorosilane, 1H,1H,2H,2H-perfluorodecyltriethoxysilane.

According to an embodiment of the present invention, for example, the hydrophobic treatment comprises modifying the surface of glass by at least one of methods such as chemical vapor deposition, soaking, and solvent evaporation.

According to an embodiment of the present invention, for example, a contact angle of the micro-channel array plate after the hydrophobic treatment is greater than 90°.

Examples of the present invention further provides a device for generating droplets using the micro-channel array plate prepared by the above method, comprising: a micro-channel array plate and a collecting device which are coordinated with each other, and an acceleration generating device, wherein the micro-channel array plate contains a first liquid, the collecting device contains a second liquid, and the second liquid contains an oil phase and a surfactant.

According to an embodiment of the present invention, for example, in the device, the first liquid is an aqueous phase liquid, which is a sample for biological reaction, comprising: a mixture for digital polymerase chain reaction, a cell suspension, a bacterial suspension, a DNA solution for genomic amplification, a mixture for RNA reverse transcription, a mixture for protein crystallization, a mixture for inorganic salt crystallization, a pathogen solution or suspension, a mixture for polymerization reaction, a mixture for gelation reaction, etc.; and the second liquid is an oil phase liquid containing a surfactant.

According to an embodiment of the present invention, for example, in the device, the oil phase in the second liquid is at least one of mineral oil (for example, low-boiling mineral oil, light mineral oil, etc.), silicone oil (for example, oligomeric dimethylsiloxane, cyclopentasiloxane, aliphatic siloxane, phenyl siloxane, fluorosiloxane, etc.), fatty acid glyceride (glyceryl dilaurate, glyceryl oleate, glyceryl linoleate, glyceryl stearate, glyceryl linolenate, glyceryl isostearate, glyceryl sorbate, etc.), double carbonate (for example, bis(4-methyl-octyl) carbonate, dihexadecyl carbonate, disorbide carbonate, bis(2-ethylhexyl) carbonate, bis(2-ethyloctyl) carbonate, bis(2-ethyldecyl) carbonate, bis(4-methyl-nonyl) carbonate, bis(3-methyl-decyl) carbonate, di-n-octyl carbonate, etc.), isopropyl laurate, hexyl laurate, heptyl laurate, octyl laurate, hexyl maleate, octyl maleate, isopropyl palmitate, butyl palmitate, hexyl palmitate, t-butyl palmitate, lauryl sorbate, edible rapeseed oil, sunflower seed oil, castor oil, peanut oil, and tea seed oil.

According to an embodiment of the present invention, for example, in the device, the surfactant in the second liquid is one of, or a combination of more of sodium hexadecyl sulfonate, Tween® 20, Tween® 21, Tween® 40, Tween® 60, Tween® 61, Tween® 65, Tween® 80, Span® 20, Span® 40, Span® 60, Span® 80, Span® 83, Span® 85, Span® 120, Abil® we09, Abil® em90, Abil® em120, Abil® em180, Dow Corning® 5200, Dow Corning® ES-5300, Dow Corning® emμLsifier 10, DehympLs® SML, Cremophor® WO 7, Isolan® GI 34, Isolan® GI PDI, Tegosoft® Alkanol S 2 Pellets.

According to an embodiment of the present invention, for example, in the device, the oil phase in the second liquid is a hydrocarbon-based oil having a density slightly less than that of water, so that the aqueous phase droplets can enter the oil phase and then sink to the bottom of the oil phase without remaining on the oil surface to collide with the next generated droplets.

According to an embodiment of the present invention, for example, in the device, the oil phase in the second liquid can be solidified at a temperature of about −10° C.-20 ° C.

According to an embodiment of the present invention, for example, in the device, the collecting device is made of a thermoplastic material, for example, a thermoplastic such as ABS, PP, POM, PC, PS, PVC, PA, PMMA, or a thermoplastic rubber such as TPV, and the micro-channel array plate is sealed with the collecting device by heating.

According to an embodiment of the present invention, for example, in the device, the collecting device is a centrifugal tube.

According to an embodiment of the present invention, for example, in the device, the micro-channel array plate is coordinated with the collecting device by a fixture and placed on the acceleration generating device; wherein the fixture comprises a bolt and a connection member, and the micro-channel array plate is clamped between the bolt and the connection member, and the lower end of the connection member is connected with the centrifugal tube.

According to an embodiment of the present invention, for example, in the device, the bolt comprises a male thread and the connection member comprises a female thread; the male thread is an external thread of the bolt and the female thread is an internal thread of the connection member; the male thread and the female thread are matched with each other, there is a through hole inside the bolt, and the first liquid is added to the micro-channel array plate from the through hole; the connection member comprises a blind hole formed from an upper end face, and the blind hole forms an inner end face in the connection member; when in use, the micro-channel array plate is located above the inner end face, a through hole is formed from the inner end face to a lower end face, and the droplets generated by the micro-channel array plate enter the collecting device from the through hole; the lower end face of the connection member has an outer diameter matched with an inner diameter of the collecting device.

According to an embodiment of the present invention, for example, in the device, the connection member comprises a blind hole formed from the upper end face, and the blind hole forms an inner end face in the connection member; there is an internal thread, i.e., female thread, on an inner wall of the blind hole, and the blind hole has a diameter matched with an outer diameter of the micro-channel array plate; a through hole is formed from the inner end face to the lower end face, and the through hole is a tapered hole having a diameter gradually increasing from top to bottom, and the minimum diameter of the tapered hole is less than the inner diameter of the inner end face; when in use, the micro-channel array plate is located between the lower end face of the bolt and the inner end face of the connection member.

According to an embodiment of the present invention, for example, in the device, there is a through hole inside the bolt, and the through hole is, successively from top to bottom, a large-diameter round hole, a tapered hole, and a small-diameter round hole; the tapered hole connects the large-diameter round hole and the small-diameter round hole, and the angle of the tapered hole is 30° to 50°.

According to an embodiment of the present invention, for example, in the device, the collecting device may further comprise a switching bracket, by which the coordination with a centrifugal tube of other specifications is realized.

Examples of the present invention further provides a method for generating droplets using the above device, comprising the steps of: coordinating the micro-channel array plate with the collecting device, placing them on the acceleration generating device, adding the first liquid into the assembly of the micro-channel array plate and the collecting device and adding the second liquid into the collecting device, and setting the rotation speed of the acceleration generating device, to generate droplets.

### BRIEF DESCRIPTION OF THE DRAWINGS

To describe the technical solutions of the examples of the present invention more clearly, the accompanying drawings of the examples will be briefly described below. Apparently, the drawings to be described below merely relate to some examples of the present invention and are not intended to limit the present invention.

FIG. 1 is a flowchart illustrating the production of a micro-channel array plate;

FIG. 2 is a view of the quality detection of a micro-channel array plate, wherein the contact angle in the left image is greater than 100°, indicating successful modification, and the modification in the right image is unsuccessful;

FIG. 3 is a micrograph of a micro-channel array plate, with the left image being 10× amplified and the right image being 40× amplified;

FIG. 4 is a diagram illustrating the assembling of a bolt, a connection member, a gasket, a micro-channel array plate and a 1.5 ml centrifugal tube;

FIG. 5 is a diagram illustrating the assembling of a bolt, a connection member, a gasket, a micro-channel array plate and a 200 μL centrifugal tube;

FIG. 6 shows a bright-field image and a fluorescent image after 30 rounds of PCR after droplets of sample A are generated by a microplate; and

FIG. 7 shows a bright-field image and a fluorescent image after 30 rounds of PCR after droplets of sample B are generated by a microplate.

### DETAILED DESCRIPTION OF THE INVENTION

In order to make the purposes, technical solutions and advantages of the examples of the present invention clearer, the technical solutions of the examples of the present invention will be described clearly and completely with reference to the accompanying drawings in the examples of the present invention. Apparently, the examples described herein are some but not all of the examples of the present invention. All other examples obtained by a person of ordinary skill in the art on the basis of the examples of the present invention described herein, without paying any creative effort, shall fall into the protection scope of the present invention.

Examples of the present invention provides a method for preparing a micro-channel array plate.

The method for preparing a micro-channel array plate comprises steps of: (1) arranging two different optical fiber glass rods closely, one of which cannot be corroded by a corrosive liquid and the other of which can be corroded by the corrosive liquid, melting the two glass rods into a whole at a high temperature to obtain a melted glass rod, drawing the melted glass rod one or more times into a longer and thinner glass rod, and cutting the drawn glass rod into small pieces to obtain a micro-channel array plate blank; (2) corroding the blank to remove the core material, so as to obtain a micro-channel array plate with through holes; and (3) conducting hydrophobic treatment on the micro-channel array plate.

According to an embodiment of the present invention, the raw material for the micro-channel array plate is optical fiber glass. The glass, doped with elements such as germanium, boron, barium, lanthanum, gallium, antimony, is easy to be thermally processed. Two different kinds of optical fiber glass are used, one of which is common optical fiber glass that cannot be corroded by the dilute nitric acid, and the other of which is glass that can be corroded by the dilute nitric acid (referred to as core material). Both kinds of glass are regular hexagonal or square rods or fibers which are closely arranged in a hexagon or square. Then, at a high temperature, the glass rods are melted into a whole. Then, the melted glass rod continues to be drawn one or more times at a high temperature into an extremely long and thin glass rod (i.e., filament). In one example, the distance between opposite sides of the filament is 4 mm to 6 mm. During the arrangement of filaments, one drawing, two drawings or even many drawings may be possible. Usually, one drawing is used. For one drawing, there is only one filament arrangement, wherein most optical fiber glass filaments/rods are doped glass that cannot be corroded by acids, and a small number of filaments or their cores can be completely corroded in an acid environment. Those filaments may be regular hexagonal or square columns which are arranged in a hexagon or square to form a spliced glass rod. The hexagonal arrangement is more common. The spliced glass rods are melted into a whole at a temperature of 800° C. to 3000° C., in the presence of an external traction force at the two ends, and then, due to the external traction force, the melted glass rod is drawn into a thin glass rod or filament. For two drawings, the above drawing steps are repeated, and again, the drawn thin glass rods or filaments are arranged and then drawn. The drawn thin glass rod with an appropriate diameter is cut into glass pieces which, after being polished, can be used as the raw material for the micro-channel array plate. The thin glass rod drawn is cut into small pieces of about 1 mm, and the small pieces are then polished for many times to obtain a micro-channel array plate blank.

According to an embodiment of the present invention, the obtained blank may be corroded to form through holes therein. To corrode the blank, there may be two methods: corrosion by nitric acid and corrosion alternately by acids and alkalis. In the case of corrosion by nitric acid, the concentration of nitric acid is not greater than 1 mol/L, for example, 0.3 mol/L to 0.5 mol/L. In the first step, the glass plate is placed in dilute nitric acid and sealed, and ultrasonically oscillated in an ultrasonic cleaner for above 40 min, usually under one of the following 3 frequencies: a: 80 kHz; b: 45 kHz; and c: alternately 80 kHz and 45 kHz, for 10 minutes. The option c is most preferred. The corrosion usually lasts for 20 hr to 200 hr. For most core materials, the completely-corroded through holes can be obtained by 100 hr of corrosion. In the case of corrosion alternately by acids and alkalis, the blank is soaked in the above nitric acid solution for 1 hr and then in a 0.5 mol/L caustic soda solution for 1 hr. Through holes may be obtained by repeating this process for at most five times. During this process, the corrosion will be facilitated by ultrasonic oscillation. The used nitric acid may be, for example, in the pure grade of metal oxide semiconductor (MOS-grade), and the caustic soda may be in analytical grade. They are diluted with MilliQ ultrapure water. A small amount of fluorine ions may be doped in the corrosive liquid.

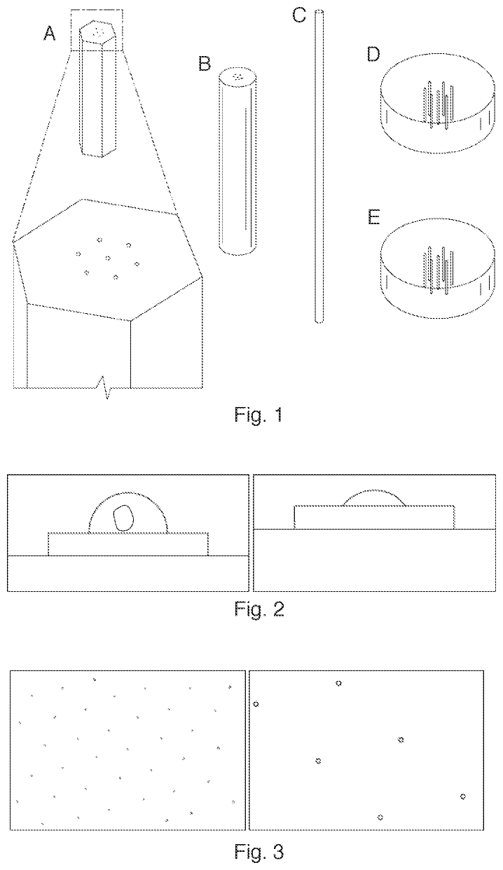

The preparation of the micro-channel array plate is shown in FIG. 1. FIG. 1A shows that a hexagonal rod-like object is spliced by two different kinds of hexagonal optical fiber glass, wherein the colorless glass is common glass that cannot be corroded by dilute nitric acid, and the black glass can be corroded by dilute nitric acid; FIG. 1B shows that the spliced hexagon object is melted into a whole at a high temperature; FIG. 1C shows that the melted glass rod is drawn at a high temperature into a long and thin glass rod that is still kept in the hexagonal structure; FIG. 1D shows that the long and thin glass rod is cut into thin pieces of 1-2 mm, which are then polished for many times to obtain a smooth surface; and FIG. 1E shows that, after corrosion by nitric acid, the core material in the thin glass pieces is corroded, with uniform holes left. The number of holes in the drawings does not represent the real situation. Usually, the openings of the holes are required to be processed to be smooth and flat, which is the key to form droplets with uniform size.

Usually, there are some silicon-oxygen bonds and silicon hydroxyls on the surface of glass. Those groups are hydrophilic. Due to those hydrophilic groups, water and aqueous solution will be spread out on the surface of glass to form a certain contact area with the surface of glass. In order to make water from the micro-channel have a spherical surface so as to fall off from the micro-channel smoothly, while ensuring that droplets falling off each time have the same size, the wetting of water or aqueous solution to the surface of glass has to be eliminated. This requires hydrophobic treatment on the micro-channel array plate. Additionally, since the micro-channel array plate provided in the example of the present invention is usually used in the biological applications, the surface is required not to absorb and adhere to substances such as nucleic acid and protein. Therefore, in an embodiment, the hydrophobic treatment is conducted with a fluorine-based hydrophobic reagent. For example, the surface of glass is modified by fluoroalkanes or fluorosilanes. Fluoroalkane is neither hydrophilic nor lipophilic and can ensure good hydrophobicity. Meanwhile, due to its low affinity with biomacromolecules, the adsorption of biological samples can be greatly reduced. Furthermore, it is easy to clean: after simple cleaning, it can be used repeatedly, basically no secondary pollution. Low dosage is another advantage of fluorosilane. The requirement on hydrophobicity can be met by a small amount of fluorosilane. The hydrophobic surface of the micro-channel array plate is one of the keys to ensure the regular falling-off of droplets. To ensure the surface of glass, which is generally hydrophilic, to be considerably hydrophobic, the surface of glass is generally modified by chemical vapor deposition. The modification step roughly includes steps of cleaning with a mixture of concentrated sulfuric acid with hydrogen peroxide, cleaning with ultrapure water, drying, oxygen radical surface activation, chemical vapor fumigation, aging, post-cleaning with ultrapure water, and the like. In addition to chemical vapor fumigation, the method of soaking may be used, which roughly includes cleaning, oxygen radical activation, soaking, aging, post-cleaning, and the like.

For example, the hydrophobic treatment includes the following steps.

1. Cleaning

The purpose of cleaning is to completely remove organic residues and inorganic salt residues on the micro-channel array plate, to guarantee the uniform chemical deposition.

a) Ultrasonic Acid Pickling

A mixture of 25% (w/w) concentrated sulfuric acid with 30% (w/w) hydrogen peroxide is prepared. About 15 mL 30% (w/w) hydrogen peroxide is poured into a 50 mL centrifugal tube and then the concentrated sulfuric acid is added dropwise by a dropper. The centrifugal tube is slightly oscillated while adding the concentrated sulfuric acid dropwise, so that the concentrated sulfuric acid is quickly mixed with the hydrogen peroxide and also the generated heat is dissipated. Addition of the concentrated sulfuric acid is stopped when the level reaches 20 mL of the centrifugal tube. During the oscillation, liquid splashing should be avoided. Therefore, it is suggested to conduct this operation in the fume hood.

After this cleaning liquid is prepared, the micro-channel array plates are gently put into the centrifugal tube one by one by a tweezer, not more than 10 every time, in order to avoid causing surface scratches due to too violent collision between the micro-channel array plates during the next ultrasonic processing. Then, the centrifugal tube, the lid of which is tightened, is put into an ultrasonic cleaner for cleaning in an automatic cleaning mode at 80 kHz and 45 kHz, alternated every 10 s. The cleaning lasts for 10 min. It is also possible that the prepared mixture of concentrated sulfuric acid with hydrogen peroxide is dispensed into 1.5 mL centrifugal tubes, into each of which about 1 mL of cleaning liquid containing concentrated acid and one micro-channel array plate are added. Then, the lid of the centrifugal tube is tightened. Such a dispensing method can fundamentally avoid the collision between the micro-channel array plates.

b) Cleaning with Water and Drying

The cleaning liquid containing concentrated acid is washed with ultrapure water. Ultrapure water is added into the ultrasonically treated centrifugal tube and then poured away. When pouring water away, attention should be paid to prevent pouring the thin glass pieces away. After repeatedly decanting with ultrapure water for five times, the thin glass pieces are transferred to a vial, to be dried in the next step. The vial with the thin glass pieces is put in a vacuum oven. The vial is dried by heating in vacuum, usually at a temperature of 70° C., for at least half an hour.

1. Oxygen Radical Activation and Vapor Fumigation

A small piece of PVC blue film (blue film, for short) is cut. The micro-channel array plates are laterally put on the blue film one by one, with no contact between the micro-channel array plates. The blue film, to which the micro-channel array plates are adhered, is put on a clean glass slide. The glass slide is then put into an oxygen radical cleaning instrument to be cleaned in vacuum under a power of above 80% for 5 min.

During the 5 min waiting period, not less than 200 μL of fluorosilane is added into a small centrifugal tube which is then put into a small vacuum drier. At the end of activation, the glass slide is put into the vacuum drier together with the blue film and the micro-channel array plates, and the lid of the drier is quickly closed after the lid of the small centrifugal tube is opened. The vacuum valve is turned off after the vacuum drier is vacuumized for 3 min. Fumigation lasts for 50 min to 1 hr at normal temperature.

The used fluorosilane may be trimethylchlorosilane, trisperfluoromethylchlorosilane, trimethoxypropylsilane, trimethoxy 1H,1H,2H,2H-perfluorooctylsilane, propyltrichlorosilane, 1H,1H,2H,2H-perfluorooctyltrichlorosilane, (2,4-difluorophenylethynyl)trimethylsilane, (3,5-difluorophenylethynyl)trimethylsilane, (3,5-bis(trifluoromethyl)phenylethynyl)trimethylsilane, triethyl(trifluoromethyl)silane, triethoxy[4-(trifluoromethyl)phenyl]silane, chlorodimethyl(pentafluorophenyl)silane, 1H,1H,2H,2H-perfluorooctyltrichlorosilane, 1H,1H,2H,2H-perfluorooctyldimethylmonochlorosilane, octyltrichlorosilane or octyldimethylmonochlorosilane, 1H,1H,2H,2H-perfluorododecyltrichlorosilane, 1H,1H,2H,2H-perfluorodecyltriethoxysilane.

2. Aging

The fumigated micro-channel array plates are taken out, stripped off from the blue film one by one, and put into the vial. The micro-channel array plates are heated by a heating device at 120° C. for 5 min. After aging, the micro-channel array plates are put in ultrapure water to be ultrasonically cleaned for 3 min, and then dried for future use.

1. Quality Inspection

Rough examination: 0.5 μL of MilliQ is added dropwise on an aged micro-channel array plate by a pipette to observe the morphology of droplets. The contact angle should be greater than 90°.

Photogrammetry: the formed droplets are shot by a camera and the contact angle is measured in the image. During the shooting, it is needed to ensure that the lower surface of droplets is viewed from the top in the lens and the included angle between the line of sight and the plane of droplets is above 0° and below 5°. Usually, a contact angle of greater than 100° indicates successful modification. FIG. 2 is a view of the quality detection of a micro-channel array plate, wherein the contact angle in the left image is greater than 100°, indicating successful modification, and the modification in the right image is unsuccessful.

The prepared micro-channel array plate is shown in FIG. 3. FIG. 3 is a micrograph of the micro-channel array plate, with the left image being 10× amplified and the right image being 40× amplified.

An example of the present invention provides a device for generating droplets using the micro-channel array plate, comprising: a micro-channel array plate and a collecting device which are coordinated with each other, and an acceleration generating device. The micro-channel array plate contains a first liquid, and the collecting device contains a second liquid.

The principle of generating droplets by inertia force is as follows: under a centrifugal force, the first liquid passes through the micro-channel with a hydrophobic surface and breaks at the end of the micro-channel into small droplets; and the droplets enters into the second liquid in the collecting device after flying in the air for a short distance, to form emulsion droplets. Droplets of the first liquid, which is in an aqueous phase, for emulsification are above the micro-channel array plate; air is below the micro-channel array plate; and the second liquid containing a surfactant, which is in an oil phase, is below air. By high-speed centrifugation, the first liquid continuously forms droplets with uniform size at the lower end of the micro-channel. Those droplets form beads like balls, due to surface tension, after flying in the air for a short distance (usually not more than 1 cm), and then enter into the second liquid. Due to the presence of the surfactant in the second liquid, the droplets can exist stably in the emulsion for a long period of time. The surfactant is soluble in oil, but almost insoluble in water. However, it has a hydrophilic group so that the surfactant forms a self-assembled monomolecular film at the interface between the oil phase and the aqueous phase. This film effectively maintains the stability of droplets, and also separates the aqueous phase from the outside. Droplets are kept in a spherical morphology, also because oil provides buoyancy support for about 80% of the gravity of droplets.

The size of droplets may be adjusted by adjusting the length and radius of the micro-channel, the centrifugal rotation speed/centrifugal acceleration, the viscosity of the first liquid, and the surface tension of the first liquid. On one hand, the speed of generating droplets is influenced by the centrifugal rotation speed, and on the other hand, when the centrifugal rotation speed is kept unchanged, the speed of generating droplets may be changed by changing the number of channels on the micro-channel array plate. A mathematic model for generating droplets by inertia force is as follows:

Parameter symbols:

There are N micro-channels with the same geometrical shape on the micro-channel array plate, and the contact area with the liquid is A;

the cross section of the micro-channel is a circle having a radius of R (m);

the area of the cross section of the micro-channel is denoted by a;

the micro-channel is 1 (m) long in the longitudinal direction;

the flow resistance to the liquid flowing through the micro-channel is denoted by Z (Pa·s/m³);

the flow volume of the first liquid per unit time is denoted by Q (m³/s);

the time is denoted by t, and centrifugation starts at t=0;

for the liquid flowing through the micro-channel array plate:

the surface tension is denoted by γ (N*m), and

the density is denoted by ρ (kg/m³);

the viscosity of the first liquid is denoted by η;

the height of the liquid above the micro-channel array plate is denoted by h (m), h=h₀ at t=0;

the total volume is denoted by U (m³);

the pressure at the exit of the dropletizing device is denoted by p (Pa);

for droplets:

the radius is denoted by r,

the diameter is denoted by d,

the volume is denoted by V, and

the mass is denoted by m;

others:

the base number of the natural logarithm is denoted by e;

mathematical equations:

The size of droplets may be adjusted by adjusting the length and radius of the micro-channel, the centrifugal rotation speed/centrifugal acceleration, the viscosity of the first liquid, and the surface tension of the first liquid. On one hand, the speed of generating droplets is influenced by the centrifugal rotation speed, and on the other hand, when the centrifugal rotation speed is kept unchanged, the speed of generating droplets may be changed by changing the number of channels on the micro-channel array plate. A mathematic model for generating droplets by inertia force is as follows:

Parameter symbols:

There are N micro-channels with the same geometrical shape on the micro-channel array plate, and the contact area with the liquid is A;

the cross section of the micro-channel is a circle having a radius of R (m);

the area of the cross section of the micro-channel is denoted by a;

the micro-channel is 1 (m) long in the longitudinal direction;

the flow resistance to the liquid flowing through the micro-channel is denoted by Z (Pa·s/m³);

the flow volume of the first liquid per unit time is denoted by Q (m³/s);

the time is denoted by t, and centrifugation starts at t=0;

for the liquid flowing through the micro-channel array plate:

the surface tension is denoted by γ (N*m), and

the density is denoted by ρ (kg/m³);

the viscosity of the first liquid is denoted by η;

the height of the liquid above the micro-channel array plate is denoted by h (m), h=h₀ at t=0;

the total volume is denoted by U (m³);

the pressure at the exit of the dropletizing device is denoted by p (Pa);

for droplets:

the radius is denoted by r,

the diameter is denoted by d,

the volume is denoted by V, and

the mass is denoted by m;

others:

the base number of the natural logarithm is denoted by e;

mathematical equations:

the equation for calculating the mass of droplets is 2π·γ·R=G·m, assuming that the gravity is equal to the surface tension, and the distance to the position where the droplets break is equal to the radius of the micro-channel, denoted by R;

the equation for calculating the mass, volume and radius of droplets is

$$m = ρ V = \frac{\text{?}}{\text{?}} π \cdot ρ \cdot {r}^{3} ;$$

$$\text{?} \text{indicates text missing or illegible when filed}$$

with an external acceleration G, the volume of droplets is

$$V = \frac{2 \text{?} R \text{?}}{\text{?}} ;$$

$$\text{?} \text{indicates text missing or illegible when filed}$$

and

the equation for calculating the radius is

$$r = \text{?} \sqrt{\frac{\text{?}}{\text{?}}} .$$

$$\text{?} \text{indicates text missing or illegible when filed}$$

Hereby, the size of the generated droplets is changed by adjusting the centrifugal rotation speed or by changing the radius R of the micro-channel.

It is assumed that the liquid flows through numerous micro-channels according to the following equation:

the flow volume

$$Q = \frac{\text{?}}{z}$$

$$\text{?} \text{indicates text missing or illegible when filed}$$

where, the pressure p=πGh

the flow resistance

$$Z = \frac{\text{?}}{\text{?}}$$

$$\text{?} \text{indicates text missing or illegible when filed}$$

Thus, the flow volume in a single micro-channel may be expressed by:

$$Q = \frac{π \text{?}}{\text{?}} .$$

$$\text{?} \text{indicates text missing or illegible when filed}$$

Hereby, the height of the liquid level may be obtained by calculus:

$$h = h \text{?} \cdot e \text{?} .$$

$$\text{?} \text{indicates text missing or illegible when filed}$$

For a micro-channel array plate having a hole diameter of 6 μm, emulsion droplets of different sizes may be obtained by different centrifugal forces.

| | Tested | Predicated | Actual value: |
|---|---|---|---|
| Rotation | diameter of | diameter of | predicated |
| speed/rcf | droplets/μm | droplets/μm | value |
| 700 | 200 | 94 | 2.12 |
| 1000 | 175 | 84 | 2.09 |
| 3000 | 103 | 58 | 1.77 |
| 5000 | 75 | 49 | 1.53 |
| 7000 | 67 | 44 | 1.53 |
| 11000 | 56 | 38 | 1.49 |
| 13000 | 53 | 36 | 1.49 |
| 15000 | 49 | 34 | 1.44 |

The difference between the predicated values and the actual values may be caused by the deviation of the model from the static assumption due to the flowing of liquid.

When his close to 0, it is considered that droplets almost completely fall off, h=0.01×h₀. In this case, 99% of the liquid flows through the micro-channel array plate. During the practical operation, it was found that there is only an extremely small amount of residual droplets, less than the limit of detection (1%) of an analytical balance. That is, the amount of residual droplets is less than 0.001 g.

For example, the first liquid is an aqueous phase liquid, which is a sample for biological reaction (it may be a mixture for digital enzyme chain reaction, a cell suspension, a bacterial suspension, a DNA solution for genomic amplification, a mixture for RNA reverse transcription, a mixture for protein crystallization, a mixture for inorganic salt crystallization, a pathogen solution or suspension, or the like); and the second liquid is an oil phase liquid containing a surfactant.

The oil phase in the second liquid may be one of, or a combination of more of mineral oil (for example, low-boiling mineral oil, light mineral oil), silicone oil (for example, oligomeric dimethylsiloxane, cyclopentasiloxane, aliphatic siloxane, phenyl siloxane, fluorosiloxane), fatty acid glyceride (glyceryl dilaurate, glyceryl oleate, glyceryl linoleate, glyceryl stearate, glyceryl linolenate, glyceryl isostearate, glyceryl sorbate), double carbonate (such as, bis(4-methyl-octyl) carbonate, dihexadecyl carbonate, disorbide carbonate, bis(2-ethylhexyl) carbonate, bis(2-ethyloctyl) carbonate, bis(2-ethyldecyl) carbonate, bis(4-methyl-nonyl) carbonate, bis(3-methyl-decyl) carbonate, di-n-octyl carbonate), isopropyl laurate, hexyl laurate, heptyl laurate, octyl laurate, hexyl maleate, octyl maleate, isopropyl palmitate, butyl palmitate, hexyl palmitate, t-butyl palmitate, lauryl sorbate, edible rapeseed oil, sunflower seed oil, castor oil, peanut oil, and tea seed oil.

The surfactant in the second liquid may be one of, or a combination of more of sodium hexadecyl sulfonate, Tween® 20, Tween® 21,Tween® 40, Tween® 60, Tween® 61, Tween® 65, Tween® 80, Span® 20, Span® 40, Span® 60, Span® 80, Span® 83, Span® 85, Span® 120, Abil® we09, Abil® em90, Abil® em120, Abil® em180, Dow Corning® 5200, Dow Corning® ES-5300, Dow Corning® emulsifier 10, Dehymuls® SML, Cremophor® WO 7, Isolan® GI 34, Isolan® GI PDI, Tegosoft® Alkanol S 2 Pellets.

For example, the oil phase in the second liquid is hydrocarbon-based oil having a density slightly less than that of water, so that the aqueous phase droplets enter and then sink to the bottom of the oil phase without remaining on the surface of oil to collide with the next generated droplets. The low viscosity of oil ensures that droplets will not be broken by the collision force when entering the oil. The specifically-formulated oil may be solidified at about 10° C., so that the emulsion can be frozen. In this way, droplets can be stored in an environment at 10° C. for a long period of time, so as to keep good morphology and separation characteristics.

The collecting device may be a centrifugal tube. Eight-row centrifugal tubes or 96-well plates are used. For example, 1.5 mL centrifugal tubes from Eppendorf or 200 μL PCR tubes from Qiagen may be used. The 200 μL PCR tubes from Qiagen should be used together with the 1.5 mL centrifugal tubes from Eppendorf, by a switching bracket. When the 1.5 mL centrifugal tubes are used, it is necessary to ensure that droplets fly not more than 8 mm, for example, within 5 mm. 700 μL to 1200 μL, for example 1000 μL, of the second liquid needs to be added. When the 200 μL PCR tubes are used, generally, 150 μL to 250 μL, for example 240 μL, of the second liquid is added.

The micro-channel array plate may be coordinated with the collecting device by a fixture and placed on the acceleration generating device. By the fixture, the micro-channel array plate is fixed during the centrifugation. Meanwhile, the fixture has a function of sealing, in order to ensure that the liquid in the micro-channel array plate will flow out only from an end of the micro-channel of the micro-channel array plate facing the collecting device, i.e., to ensure that the first liquid flows out only from the micro-channel.

The fixture, which is coordinated with the centrifugal tube, comprises a bolt and a connection member. The micro-channel array plate is clamped between the bolt and the connection member. The lower end of the connection member is connected with the centrifugal tube.

The bolt comprises a male thread and the connection member comprises a female thread. The male thread is an external thread of the bolt and the female thread is an internal thread of the connection member. The male thread and the female thread are matched with each other. There is a through hole inside the bolt, and the first liquid is added to the micro-channel array plate from the through hole. The connection member comprises a blind hole formed from an upper end face, and the blind hole forms an inner end face in the connection member. When in use, the micro-channel array plate is located above the inner end face. There is an internal thread, i.e., female thread, on an inner wall of the blind hole. The blind hole has a diameter matched with an outer diameter of the micro-channel array plate. A through hole is formed from the inner end face to a lower end face, and the droplets generated by the micro-channel array plate enter the collecting device from the through hole. The through hole is a tapered hole having a diameter gradually increasing from top to bottom. The minimum diameter of the tapered hole is less than the inner diameter of the inner end face. The lower end face of the connection member has an outer diameter matched with an inner diameter of the collecting device. When in use, the micro-channel array plate is clamped between the lower end face of the bolt and the inner end face of the connection member.

The height of the connection member is 8 mm to 15 mm, for example 11 mm. The upper end face has an outer diameter of 10 mm to 13 mm, for example 12 mm; and the inner end face has an inner diameter of 7 mm to 10 mm, for example 8.8 mm. The connection member further has a connection member head, the outside surface of which is embossed or roughened to increase the surface friction. The depth of the blind hole is, for example, 9 mm, at least 8 mm. The specifications of the internal threads may be for example in accordance with British standard 1/4-28, national standard M4 or national standard M5. The tapered through hole is continuously punched down from the inner end face, and the diameter of the through hole gradually increases from top to bottom. The minimum diameter of the through hole is 3 mm. The apex angle of the tapered hole is at least 50°, for example 60°.

The bolt has a height of 12 mm to 18 mm, for example 14.5 mm. The head of the bolt has an outer diameter of 8 mm to 13 mm, for example 10 mm. The head of the bolt has a height of about 6.5 mm, and the outside surface of the head of the bolt is embossed or roughened to increase the surface friction. There is an external thread, i.e., male thread, which is matched with the female thread, on the stem of the bolt. The specifications of the external thread may be in accordance with British standard 1/4-28, national standard M4 or national standard M5. There is a through hole inside the bolt, from which the first liquid is added to the micro-channel array plate. The through hole is, successively from top to bottom, a hole having a diameter of 7 mm, a tapered hole, and a hole having a diameter of 3 mm. The hole having a diameter of 7 mm has a height of 3 mm. The tapered hole connects the hole having a diameter of 7 mm and the hole having a diameter of 3 mm. To form the through hole, first, a through hole having a diameter of 3 mm is punched upward from the lower surface; then, a hole having a diameter of 7 mm and a depth of 3 mm is punched downward from the upper surface; and then a tapered surface, the diameter of which gradually decreases downward, is punched downward from the above hole until the tapered surface is tangent to the through hole having a diameter of 3 mm. The angle of the tapered surface (on a single side) is 30° to 50°, for example 45°.

Both the bolt and the connection member may be made of PEEK.

A sealing gasket is further provided between the micro-channel array plate and the inner end face of the connection member. The sealing gasket is a circular ring having an outer diameter of about 5 mm and an inner diameter of about 3 mm. The thickness of the sealing gasket is 0.2 mm to 2 mm, for example 1 mm. The sealing gasket may be made of PEEK (polyetheretherketone) plastic without doped with fiberglass by fine machining or may be cut from a flexible panel. A gasket cut from polytetrafluoroethylene (Teflon) is most preferred. The gasket may also be made of rubber.

When the micro-channel array plate and the fixture are assembled, first, the micro-channel array plate is put flatwise on the inner end face of the connection member by a tweezer, and one gasket is put flatwise, and then the bolt is tightened. The assembly of the fixed micro-channel array plate and the fixture is called the clamped micro-channel array plate. If, after the bolt is tightened, the bolt is untightened and the gasket is taken out, it is necessary to replace the gasket with a new gasket to avoid poor sealing.

The collecting device may be made of a thermoplastic material, for example, a thermoplastic such as ABS, PP, POM, PC, PS, PVC, PA, PMMA, or a thermoplastic rubber such as TPV, and the micro-channel array plate is sealed with the collecting device by heating.

The acceleration generating device is a centrifuge equipped with a basket-type centrifuge tube rack, which can provide a centrifugal acceleration of at least 160000 m/s².

An example of the present invention provides a method for generating droplets using the device for concurrently generating droplets by the micro-channel array plates, comprising the steps of: coordinating the micro-channel array plate with the collecting device, placing them on the acceleration generating device, adding the first liquid into the dropletizing device and adding the second liquid into the collecting device, and setting the rotation speed of the acceleration generating device, to generate droplets.

The examples of the present invention have the following beneficial effects:

1) Generation of uniform droplets: The micro-channel array plates can be produced in such a manner that the channels have a small difference in radius. The relative standard deviation may be controlled within 3%. Furthermore, the production process can be highly repeated, with small difference in the previous and latter batches. Therefore, uniform emulsion droplets can be generated in multiple channels in multiple batches.

2) Adjustability: The micro-channels of the micro-channel array plates can be arbitrarily designed in different diameters. The size of the generated droplets can be adjusted by the centrifugal force. Unlike the indefinite adjustment rule in generation of droplets by microfluidic chips (in which case, the size of droplets is adjusted by adjusting the pressure or flow rate of the two phases), there are definite and simple mathematic laws in adjusting the size of droplets when droplets are generated on the micro-channel array plate by centrifugation.

3) Stability: Once the hole diameter of the used micro-channel array plate and the centrifugal force are determined, the size of droplets will not change. Samples with a tiny amount of solid impurities, for example unfiltered biological sample treatment fluid, can be accepted. If blockage occurs, the device can be used again after simple cleaning. In contrast, in the method for generating droplets by microfluidics, the diameter of droplets will be influence by the flow resistance of the pipeline, the flow resistance of the liquid and the perturbation, etc. Furthermore, there is only one droplet nozzle, and the experiment fails once this droplet nozzle is blocked. The ports of capillary tubes are easy to be blocked due to their preparation process.

4) Mass production, simple structure and low cost: The micro-channel array plates can be draw from optical fiber, and can be ground, corroded and modified in batches. The increase in the number of channels will not increase the processing difficulty, and a large number of consistent micro-channel array plates can be obtained, and the micro-channel array plates can be disposable. The PEEK fixture can be produced by injection molding which is low in cost. In contrast, the microfluidic chips need to be produced by MEMS process, bonded and encapsulated. This process is complex and high in cost. In addition, at present, if it is needed to form such a tiny port in a capillary tube, the only way is to draw a thin end from borosilicate glass at a high temperature and then snip the end. This process is less reproducible and is low in yield. Moreover, with the increase in the number of channels, the processing difficulty will be greatly increased. Meanwhile, it is convenient to package micro-channel array plates due to their better mechanical property. The packaging of capillary tubes is complex since the micro-channels in the capillary tubes are easy to bend or break.

5) Controllable temperature: A low-temperature centrifuge can be used (for example, eppendorf 5430R). In the conventional method for generating droplets by microfluidic chips, to reduce the temperature, it is necessary to reduce the temperature of the sample chamber, pipeline, chips and some of driving devices, resulting in complex operation.

6) Sample-saving: There may be only an extremely small amount of residual samples, due to the extremely small volume of the channels of the micro-channel array plate. In contrast, inevitably, there are samples, which cannot be consumed, in the feeding pipeline of the microfluidic chips; and since the capillary tube, narrowed only at its port, has a length that is several times of that of the micro-channel array plate, waste of samples is caused.

7) High throughput: A micro-channel array plate can be designed with more than 100 or even 1000 holes, which can greatly increase the droplet generation speed and the throughput. Meanwhile, a more miniature design is also possible. Furthermore, a large number of quality inspections can be conducted simply and quickly by electron microscopes.

8) Compared with the generation of droplets by microfluidics and the centrifugation by a single orifice, the solutions provided in the examples of the present invention can completely dropletizing the biological samples, without dead volume, such that the biological samples can be utilized to a greater extent, and more information can be obtained to reflect a more comprehensive and true situation.

### EXAMPLE 1

### Coordination of the Micro-Channel Array Plate with the Collecting Device

Coordination of the micro-channel array plate with the 1.5 mL centrifugal tube:

1 mL of the second liquid was added into a centrifugal tube. The second liquid should be slowly added because it is quite easy to form bubbles. Once bubbles are formed, air of the bubbles is quickly blown by a 1 mL pipette with a new tip. In this way, the bubbles can be broken.

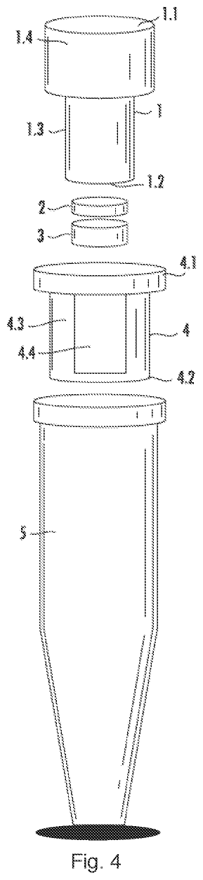

The drawing of assembling is shown in FIG. 4, in which: 1: bolt; 1.1: the head of the bolt; 1.2: the lower end face of the bolt; 1.3: male thread; 1.4: through hole; 2: gasket; 3: micro-channel array plate; 4: connection member; 4.1 the head of the connection member; 4.2: the lower end face of the connection member; 4.3: female thread; 4.4: inner end face; 5: 1.5 mL centrifugal tube (with its lid omitted). The micro-channel array plate was fixed by tightening the two kinds of threads, and then gently put in the centrifugal tube filled with the second liquid.

Coordination of the micro-channel array plate with the 200 μL centrifugal tube:

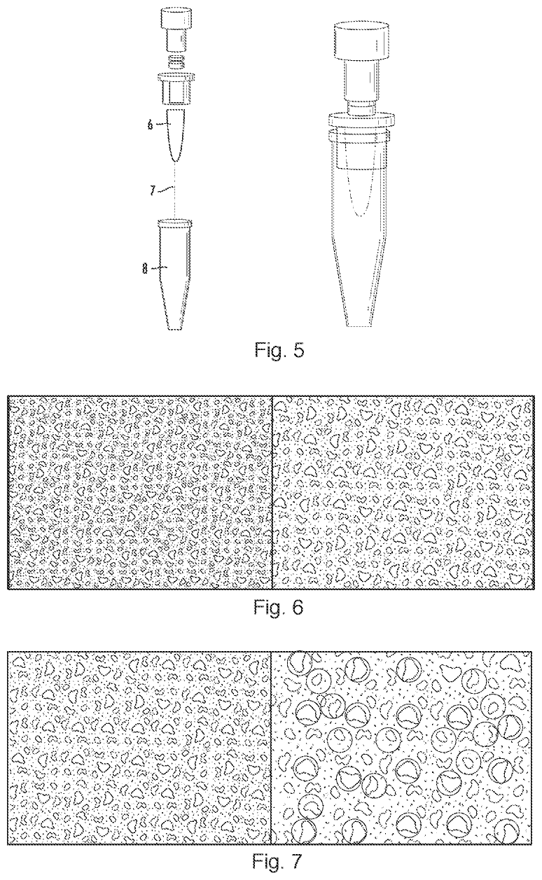

The drawing of assembling is shown in FIG. 5. The positional relationship between the bolt, the gasket, the micro-channel array plate and the connection member is the same as that shown in FIG. 4, in which: 6: 200 μL centrifugal tube; 7: switching bracket; and 8: 1.5 mL centrifugal tube. When in use, first, the micro-channel array plate and the gasket are put flatwise in the connection member, successively, and then tightened by the bolt to obtain a micro-channel tube; then 200 μL of the second liquid is added into the 200 μL centrifugal tube; the lid of the 200 μL centrifugal tube is snipped, and the 200 μL centrifugal tube is put into a 1.5 mL centrifugal tube having a switching bracket therein, by holding its upper portion by a tweezer; and finally, the micro-channel tube is put in the 1.5 mL centrifugal tube, with the micro-channel tube being supported by the edge of the 1.5 mL centrifugal tube. The switching bracket is obtained by 3D printing.

When they are assembled, during the generation of droplets, 20 μL to 100 μL of samples in an aqueous phase is added by a pipette to the micro-channel array plate from the through hole of the bolt. The centrifugation is conducted in a high-speed centrifuge for several minutes. The centrifuge is equipped with a basket-type rotor to ensure that the direction of the centrifugal tube is consistent with the direction of a resultant force of the centrifugal force and the gravity. In this way, droplets fall onto the bottom of the centrifugal tube, rather than adhering to its wall.

### EXAMPLE 2

Droplets generated by the device of the present invention are used in TaqMan probe-based digital polymerase chain reaction (dPCR) to detect trace DNA samples.

In this example, the second liquid is formulated by a solution of isopropyl laurate/Abil em 180 v/v 83/17, and the collecting device is a 1.5 mL centrifugal tube.

Method for preparing the first liquid:

The following mixture (1) was prepared first, wherein the primer is a primer designed according to a sequence in lambda phage DNA which is 223 bp long and is used for PCR amplification. Meanwhile, the TaqMan probe is also designed on the basis of this sequence.

| Every 99 μL | Dosage |
|---|---|
| Platinum Buffer-Mg(II) 10X | 10 μL |
| MgCl2 50 mM | 10 μL |
| Forward Primer l0 μM | 10 μL |
| Reverse Primer 10 μM | 10 μL |
| TaqMan Probe 3 μM | 10 μL |
| dNTP l0 mM each | 4 μL |
| Platinum Taq Polymerase, | 1 μL |
| Nuclease free water | 44 μL |

After the mixture (1) was obtained, 99 μL of the mixture was added in a 1 μL DNA template. This DNA template is the resulting product of purification by the agarose gel, the concentration of which is determined by Nanodrop. 1 μL of 1.00*10⁶ copies and 1 μL of 1.00*10⁵ copies were added in the 99 μL of the mixture (1) respectively to obtain a reaction sample A and a reaction sample B.

Wherein:

| | A | B |
|---|---|---|
| DNA concentration | 1.00*10⁴/μL | 1.00*10³/μL |

20 μL of A and 20 μL of B were added to two clamped micro-channel array plates from the through hole of the bolt, respectively, and centrifuged at 13000rcf for 4 min to obtain uniform emulsion droplets. After 30 rounds of PCR, the droplets were spread out in a hydrophobic culture dish to be observed by fluorescence microscopes, respectively shown in FIG. 6 and FIG. 7.

Sample A: In the same field of view, the left image of FIG. 6 is a bright-field image and the right image is a fluorescent image (in which, the diameter of droplets is 50 μm in average and the volume CV is 18%). Theoretically, each droplet contains 0.66 DNA molecules and 48.1% of droplets are fluorescent. The actually measured value is 49.0 (+/−0.5)%.

Sample B: In the same field of view, the left image of FIG. 7 is a bright-field image and the right image is a fluorescent image (in which, the diameter of droplets is 65 μm in average and the volume CV is 23%). Theoretically, each droplet contains 0.14 DNA molecules and 13% of droplets are fluorescent. The actually measured value is 15 (+/−0.9)%.

The foregoing description merely shows exemplary embodiments of the present invention and is not intended to limit the protection scope of the present invention. The protection scope of the present invention is defined by the appended claims.

The present application claims the priority of the Chinese Patent Application No. 201610409019.0, filed on Jun. 12, 2016, the entire disclosure of which is hereby incorporated by reference as part of the present application.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A method comprising:
generating droplets for use in digital polymerase chain reaction (dPCR), upon forcing a first liquid, under a centrifugal force, through a micro-channel array plate and into a collecting container containing a second liquid.

2. The method of claim 1, wherein said droplets each have a diameter from 34 μm to 200 μm.

3. The method of claim 1, wherein the first liquid is immiscible with the second liquid, and wherein generating said droplets comprises generating an emulsion for use in dPCR.

4. The method of claim 1, wherein the first liquid is an aqueous phase liquid.

5. The method of claim 1, wherein the first liquid comprises a mixture comprising a forward primer, a reverse primer, and a probe.

6. The method of claim 1, wherein the second liquid is an oil phase liquid.

7. The method of claim 1, wherein the second liquid comprises a silicone oil and a surfactant.

8. The method of claim 1, wherein the second liquid has a density less than that of water, such that said droplets sink to a bottom portion of the second liquid within the collecting container.

9. The method of claim 1, wherein the micro-channel array plate comprises 100 microchannels.

10. The method of claim 1, wherein the micro-channel array plate comprises 1000 microchannels.

11. The method of claim 1, wherein the micro-channel array plate has a hydrophobic surface treatment.

12. The method of claim 1, wherein the centrifugal force is applied at over 3000 relative centrifugal force (rcf).

13. The method of claim 1, wherein forcing the first liquid through the micro-channel array plate comprises transmitting 99% of the first liquid through the micro-channel array plate under the centrifugal force and into the collecting container.

14. The method of claim 1, further comprising performing polymerase chain reaction with said droplets.

15. The method of claim 13, wherein said droplets are fluorescent and observable with fluorescent imaging.

16. A method comprising:
generating droplets for use in digital polymerase chain reaction (dPCR), upon forcing a first liquid through a micro-channel array plate and into a collecting container containing a second liquid;
performing said dPCR reaction; and
observing fluorescence from said droplets with fluorescent imaging.

17. The method of claim 16, wherein the micro-channel array plate comprises 100 micro-channels.

18. The method of claim 16, wherein the first liquid comprises an aqueous phase mixture comprising a forward primer, a reverse primer, and a probe, and wherein the second liquid comprises an oil phase liquid.

19. The method of claim 16, wherein generating said droplets comprises applying a centrifugal force to the first liquid.

20. The method of claim 16, wherein the second liquid has a density less than that of water, wherein said droplets sink to a bottom portion of the second liquid within the collecting container, and wherein generating said droplets comprises generating an emulsion.
